(19) United States
(12) Patent Application Publication
(10) Pub. No.: US 2010/0090804 A1
(43) Pub. Date: Apr. 15, 2010

(54) CONTACTLESS TRANSMISSION ELEMENT AND METHOD OF CHARACTERIZING THE SAME

(75) Inventors: Bernhard Gruber, Gratwein (AT); Dirk Morgenroth, Graz (AT); Christian Schwar, Graz (AT)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP, B.V., Eindhoven (NL)

(21) Appl. No.: 12/530,855

(22) PCT Filed: Mar. 12, 2008
(86) PCT No.: PCT/IB2008/050897

§ 371 Date: Sep. 11, 2009

(30) Foreign Application Priority Data
Mar. 19, 2007 (EP) 07104417.6

(51) Int. Cl. H04Q 5/22

(52) U.S. Cl. 340/10.2; 340/10.51

(57) ABSTRACT

A method of characterizing a contactless transmission element (100) is provided, wherein the method comprises sampling a first value of a first physical parameter indicating a property of a contactless transmission element (100), and determining an interference reliability value for the contactless transmission element (100) based on the sampled first value of the first physical parameter. In particular, this interference reliability value may relate to a liability of the contactless transmission element (100) to an external field or to external influences.

### FIELD OF THE INVENTION

The invention relates to a method of characterizing a contactless transmission element.

Furthermore, the invention relates to a method of placing a contactless transmission element on an object.

Beyond this, the invention relates to a contactless transmission element. Moreover, the invention relates to a computer-readable medium.

Additionally, the invention relates to a program element.

### BACKGROUND OF THE INVENTION

To maximize the benefit of RFID installations, a good understanding of the environment and the respective influence on the used technology is important. Especially with higher frequencies, the quality of the environment on which an antenna of an RFID-tag/label is placed is affecting the parameters of the antenna and thus affecting the performance of the said RFID device.

A common RFID performance monitoring system, as known from WO 2006/115756 may include systems, methods, or computer program products for collecting information related to the performance of an RFID system. In particular, signal strength and/or signal sensitivity of the individual RFID tags may be measured and the resulting performance information may be stored in a data repository. In the data repository, the performance information for an individual tag may be associated with an identifier that is uniquely associated with the tag. It is known that the performance information may be used by an on-line system configured to automatically determine the performance margin with which RFID tags are being read in an RFID system, or to automatically tune the RFID system to achieve a desired performance margin.

Furthermore, the objects/products that should be used with RFID technology can be simulated to get an understanding of their influence on RFID devices and their respective antenna. However, the accuracy of these simulations depend on the accuracy of the model on one hand and on the limitations in terms of variations of different real life scenarios on the other hand.

### OBJECT AND SUMMARY OF THE INVENTION

It is an object of the invention to provide a method of characterizing a contactless transmission element, a method of placing a contactless transmission element on an object, a contactless transmission element, a computer-readable medium, and a program element, wherein the method may yield an improved signal quality and/or strength of a signal transmitted by the contactless transmission element.

In order to achieve the object defined above a method of characterizing a contactless transmission element, a method of placing a contactless transmission element on an object, a contactless transmission element, a computer-readable medium, and a program element, according to the independent claims are provided.

According to an exemplary embodiment a method of characterizing a contactless transmission element is provided, wherein the method comprises sampling a first value of a first physical parameter indicating a property of a contactless transmission element, and determining an interference reliability value for the contactless transmission element based on the sampled first value of the first physical parameter. In particular, this interference reliability value may relate to a liability of the contactless transmission element to an external field or to external influences.

According to an exemplary embodiment, a method of placing a contactless transmission element on an object is provided, wherein the method comprises reading an interference reliability value determined by carrying out the method according to an exemplary embodiment, correlating the interference reliability value for the contactless transmission element with an impact value of the object, wherein the impact value characterizes an impact of the object on a transmission of the contactless transmission element, and placing the contactless transmission element on the object based on the result of the correlation.

According to an exemplary embodiment a contactless transmission system is provided, which comprises a contactless transmission element, and an information storing element adapted to store information indicative for an interference reliability value for the contactless transmission element. In particular, the interference reliability value is stored in the information storing element.

According to an exemplary embodiment, an attaching system for attaching a contactless transmission element onto an object is provided, wherein the system comprises a contactless transmission element attaching unit, and a reading unit, wherein the reading unit is adapted to read an interference reliability value determined according to a method according to an exemplary embodiment. Furthermore, the reading unit is further adapted to read an impact value of the object, wherein the impact value characterizes an impact of the object on a transmission of the contactless transmission element, and the contactless transmission element attaching unit is adapted to attach a specific contactless transmission element based on the read interference reliability value and on the read impact value.

According to an exemplary embodiment, a program element is provided, which, when being executed by a processor, is adapted to control or carry out a method of characterizing a contactless transmission element, wherein the method comprises sampling a first value of a first physical parameter indicating a property of a contactless transmission element, and determining an interference reliability value for the contactless transmission element based on the sampled first value of the first physical parameter.

According to an exemplary embodiment a computer-readable medium is provided, in which a computer program is stored which, when being executed by a processor, is adapted to control or carry out a method of characterizing a contactless transmission element, wherein the method comprises sampling a first value of a first physical parameter indicating a property of a contactless transmission element, and determining an interference reliability value for the contactless transmission element based on the sampled first value of the first physical parameter.

In particular, data processing or signal processing which may be performed according to embodiments of the invention can be realized by a computer program, that is by software, or by using one or more special electronic optimization circuits, that is in hardware, or in hybrid form, that is by software components and hardware components.

The term “physical parameter” may particularly denote a parameter which relates to a physical quantity of the contactless transmission element like length, energy, time, current, relative dielectric constant or the like. In particular, it may not relate to a transmission quality itself, but to a parameter which can be used to determine the transmission quality of a signal. Such “physical parameters” may in particularly be the relative dielectric constant, the relative permeability and the so-called lossy angle.

The term “contactless transmission element” may particularly denote an element which is adapted to transmit, emit or receive a signal, e.g. a radio frequency signal, an infrared signal, an acoustic signal or the like, which signal may include information or may be able to communicate information. In this context it should be noted that the information may be either transmitted by actively emitting a signal, or by passively changing a signal emitted by another device. The contactless transmission element may also be called transponder and may be an RFID-tag. Thus, in a broader sense it is also denoted as transmitting a signal when a passive device, e.g. an RFID-tag, changes the frequency of a signal emitted by another device, e.g. an RFID-reader, e.g. by changing a load the sender of the RFID-reader is exposed to.

The term “interference reliability value” may particularly denote a value which characterizes the susceptibility or interference of the contactless transmission element to an external influence. The “interference reliability value” may be in particular depend on the measured value of the first physical parameter, i.e. is a function of this value. Alternatively, also the measured value of the first physical parameter itself may form the “interference reliability value”, since also this measured value is indicative of a liability to external influences of the contactless transmission element. The “interference reliability value” may in particular relate to the transmission quality of the signal. That is, the “interference reliability value” may correspond to a perturbation of a given signal to be transmitted. For example, the interference reliability value may characterize the extent of the impact of an electric or magnetic field on a transmission of a signal of the contactless transmission element. Thus, the interference reliability value may correspond to a characteristic of the contactless transmission element, while an impact value may characterize the extent the object may influence the reliability of the contactless transmission element. Thus, it may be possible to say that “impact value” and “interference reliability value” are complementary in that sense that the impact value of a specific object may characterize the extent the object may influence a contactless transmission element while the interference reliability value of a specific contactless transmission element may characterize the extent the contactless transmission element is influenced by an impact value of an object. Such an impact value may in particular characterize at least a portion of the object. In particular, several values of the physical parameter may be measured, e.g. for different positions of the object so that a mapping of the surface of the object may be possible. In this context the term “impact value” or “influence value” may particularly denote the magnitude or extent a given signal, which is to be transmitted is influenced or affected when the magnitude of the physical parameter is changed. For determining the “impact value” a method of and a device for characterizing an object may be used, in which the object is sampled or scanned by a sensor unit which sensor unit is adapted to measure a physical parameter. Then a determination unit may determine, on basis of the measured parameter, an impact value, e.g. a value which is indicative for the magnitude a specific contactless transmission element, e.g. an RFID-tag, is disturbed by the object, in particular in case the contactless transmission element is arranged on the object. Thus, it may be possible to place a given contactless transmission element in such a way onto the object that it is least influenced by the object, e.g. at least the portion of the contactless transmission element which is most sensitive to influences of the object may be placed over a portion of the object which will least influence the contactless transmission element.

It may be seen as a gist of an exemplary aspect of the invention that a method of characterizing an RFID-tag or RFID-label is provided, wherein the RFID-tag is characterized according to a chosen physical parameter, e.g. for example the relative dielectric constant, the quality factor, the relative permeability. That is, the respective parameter(s) may be measured or sampled, and based on this parameter(s) an interference reliability value is determined or calculated, which may represent to which extent the RFID-tag may be influenced by an object, e.g. a product the RFID-tag shall be arranged on. To achieve better accuracy of the characterization and thus possibly a better interference reliability value, the characterization process may be split into several subsets along the interfering surfaces of the RFID-tag, e.g. along a respective antenna.

That is, the total area of the RFID-tag may be divided into a plurality of sub-areas and for each sub-area a respective value of the physical parameter(s) are sampled and afterwards respective interference reliability values are determined for each sub-area. The sampling may in particular performed by measurements of the respective physical parameter(s) while the RFID-tag is exposed to an electric or magnetic field similar to the field generated by an interrogator adapted to read the RFID-tag, or may be performed by simulation. One way to measure the respective physical parameter(s) may be to place the RFID-tag in a fix distance in front of an RFID-reader antenna inside an anechoic chamber and increase the output power of the reader as long as the RFID-tag starts to operate. Alternatively, the opposite procedure may be used, where the output power of the reader is decreased, after starting from a maximum.

According to this exemplary aspect, the profile, i.e. the interference reliability values for each sub-area, may be stored into a memory of the RFID-tag or RFID-label in such a way that it is readable by an interrogator that is used in an application of the RFID-tag once the profile is known. Alternatively, the profile of the RFID-tag or RFID-label may be printed or represented in any manner on the RFID-tag/label itself, or on a reel that holds a certain batch of RFID-labels or inlays. In particular, the profile may be determined dependent on a frequency of the interrogator and/or of the RFID-tag, that is a frequency the transmission of a signal is performed. This may in particular useful, since the interference reliability value of the RFID-tag may depend on the frequency.

By storing the sensitivity of the RFID-tag in such a manner that it can be correlated to the RFID-tag, it may in particular possible to chose either an RFID-tag which is most suitable for a given product or to place the RFID-tag on the product in such a way that the portion which is least sensitive to the influence of the product is placed at an area of the product which exhibits the lowest influence on the RFID-tag. According to this exemplary aspect it may be possible to avoid that the possible influences of an object onto the contactless transmission element must be simulated to get an understanding of its influence on the contactless transmission element and respective sending/receiving units, e.g. antennas, which simulation is a known way to analyze possible influences. The accuracy of these simulations depend on the accuracy of the model on one hand and on the limitations in terms of variations of different real life scenarios on the other hand.

Contrary to that, according to an exemplary embodiment of the invention, the influences may be directly determined on measured values of physical parameter(s). Thus, by using a method according to an exemplary embodiment of the invention it may be also possible to avoid a common trial and error procedure. In known procedures a good understanding of the used RFID-tag is assumed, with respect of its efficiency and assembly process. Furthermore, the known procedures require an enormous amount of runs to find a suitable place or position to arrange the RFID-tag. In such known simulation techniques the accuracy is typically limited by the form-factor of the used RFID-tag, and the sensitivity of the used RFID-tag antenna that is affected by the environmental influence, while by using a method according to this exemplary aspect these limitations may not be given. In particular, it may be possible to place a given RFID-tag in such a way onto the object that it is least influenced by the object, e.g. at least the portion of the RFID-tag which is most sensitive to influences of the object may be placed over a portion of the object which will least influence the RFID-tag.

Next, further exemplary embodiments of the method of characterizing a contactless transmission element are described. However, these embodiments also apply to the method of placing a contactless transmission element on an object, the contactless transmission element, the computer-readable medium, and the program element.

According to another exemplary embodiment, the method further comprises storing the determined interference reliability value. In particular, the interference reliability value may be stored on the contactless transmission element itself. This storing may be performed by printing an indication or indicia on the contactless transmission element corresponding to the interference reliability value or may be performed by storing the interference reliability value on a memory of the contactless transmission element. In particular, the indicia may be a bar code or the like. Alternatively to storing the interference reliability value, the value of the first physical parameter itself may be stored. As already described, the value of the first physical parameter may also be called an interference reliability value since it has an effect on the quality of the transmission of a signal.

By storing the interference reliability value direct onto the contactless transmission element, it may be ensured that always the correct interference reliability value is associated with each contactless transmission element so that it may be read before the application of the respective contactless transmission element.

According to another exemplary embodiment of the method, the interference reliability value is stored on a carrier element of the contactless transmission element. In particular, on a reel or a unit a batch of contactless transmission elements is stocked on or holded on.

By storing the interference reliability value on a carrier element of the contactless transmission element it may be ensured that the correct reliability has only to read once for a whole batch of contactless transmission elements before the respective contactless transmission elements are placed on an object or product.

According to another exemplary embodiment, the method further comprises sampling a plurality of values of the first physical parameter. In particular, each of the plurality of values of the first physical parameter may be indicative of a property of a respective portion of the contactless transmission element. According to another exemplary embodiment, the method further comprises determining a plurality of interference reliability values based on the plurality of sampled values of the first physical parameter.

By dividing the contactless transmission element into a plurality of sub-areas or portions it may be possible to characterize the contactless transmission element in a better accuracy, thus possibly leading to an improved transmission of a signal by the contactless transmission element, since the respective contactless transmission element may be placed in such a way that at least the portion of the contactless transmission element which is most sensitive to influences of the object may be placed over a portion of the object which will least influence the contactless transmission element.

According to another exemplary embodiment, the method further comprises estimating a specific interference or interference reliability value based on the plurality of interferences or interference reliability values. In particular, the estimating is performed by selecting the minimum value of the plurality of interference reliability values or by calculating the mean value of the plurality of interference reliability values. That is, this specific interference or interference reliability value may represent the minimum value relating to the specific portion of the contactless transmission element which is least sensitive to an external field or external influence.

According to another exemplary embodiment the method further comprises storing a position value, wherein the position value corresponds to the portion of the contactless transmission element the estimated specific interference reliability value corresponds to. In particular, the stored position may correspond to the portion of the contactless transmission element which features the estimated interference value, e.g. the minimum value of the plurality of interference reliability values.

By storing such a specific interference value or interference reliability value, e.g. the minimum value, it may be possible to increase the efficiency of identifying a suitable contactless transmission element for a given application, e.g. for attaching onto a specific product.

According to another exemplary embodiment of the method, a plurality of information values is stored which relate to the interference reliability value. In particular, at least one of the plurality of information values is one out of a group consisting of: a length of the contactless transmission element, a width of the contactless transmission element, the type of the first physical parameter, a position on the contactless transmission element which position is associated with the lowest interference reliability value, a position of an area on the contactless transmission element wherein the area is associated with a substantially constant interference reliability value and an operating frequency of the contactless transmission element.

All this information may be suitable information which have influence on the interference reliability value and/or on a determination process to find out an optimum positioning of the contactless transmission element on a product. For example, the knowing of the type of the first physical parameter and/or the further physical parameter(s), e.g. relative dielectric constant, relative permeability or lossy angle, may be advantageous in order to know the parameter which has to be taken into account when examining or measuring an object the contactless transmission element shall be applied to. As a further example, the position on the contactless transmission element which position is associated with the lowest interference reliability value may relate to the central position of an area having the optimal value of sensitivity or reliability. The storing and thus providing an easy access to the corresponding value may ensure that during application of the contactless transmission element the same can be attached to the optimum position on the object. This position may be stored in a two-dimensional array, e.g. as an x-position and an y-position, for example in inch or in centimeter.

According to another exemplary embodiment of the method the first physical parameter is one out of a group consisting of: relative permeability, relative dielectric constant, and lossy angle or loss also called quality, e.g. the ratio of active energy to total energy, which may also be expressed by an angle, e.g. tan(δ). All of the above physical parameters may be measured per area, i.e. as relative permeability per square meter, relative dielectric constant per square meter, or loss angle (tan δ) per square meter.

All these physical parameters may be suitable parameters to determine an interference or interference reliability value of the contactless transmission element, i.e. a value which is indicative for a transmission quality of a signal of a contactless transmission element, under given conditions of the environment, e.g. conditions of an object the contactless transmission element is attached to. In particular, the relative dielectric constant or the relative permeability of the object may have an influence on a frequency associated with an RFID-tag, e.g. an UHF RFID-tag or an HF RFID-tag.

According to another exemplary embodiment, the method further comprises sampling a second value of a second physical parameter. In particular, the second physical parameter is also indicative for a property of the contactless transmission element. The value of the first physical parameter and the value of the second physical parameter may be indicative for the same or for different properties of the contactless transmission element. In particular, the first physical parameter and the second physical parameter may be different physical parameters out of the above described group.

According to another exemplary embodiment of the method the sampling is done by using a field simulator, adapted to generate an electro-magnetic field. In particular, a field simulator may be used which has been used to design a transmission element of the contactless transmission element, e.g. an antenna of an RFID-tag.

Next, further exemplary embodiments of the contactless transmission element are described. However, these embodiments also apply to the method of characterizing a contactless transmission element, the method of placing a contactless transmission element on an object, a computer-readable medium, and the program element.

According to another exemplary embodiment of the contactless transmission system the contactless transmission element is an RFID-tag. In particular, the RFID-tag may be an UHF-RFID-tag or an HF-RFID-tag.

RFID-tags may be efficient contactless transmission elements which may be used to store and transmit information about an object they are affixed to a reader unit in a contactless manner.

According to another exemplary embodiment of the contactless transmission system, the contactless transmission element and the information storing element are arranged on a common substrate. In particular, the information storing element may be a dedicated memory of the contactless transmission element, e.g. a memory of an RFID-tag.

According to another exemplary embodiment of the contactless transmission system the information storing element is arranged on a stocking structure of the contactless transmission element. In particular, a stocking structure or holding structure may be a reel a plurality of information storing elements, e.g. RFID-tags, is stocked or rolled on.

According to another exemplary embodiment of the contactless transmission system the information storing element is one out of a group consisting of: an RFID-tag, a bar code and a machine-readable medium.

Summarizing, one exemplary aspect of the invention may be seen in a method that does a characterization of contactless transmission elements, like RFID-tags, with respect to their relevant parameters via a sampling or measurement of the selected parameter. The generated data may be used to detect the area that is less influenced or affected by an object, e.g. a product, the RFID-tag or RFID-label is affixed to and therefore may enable best performance of the used technology. Thus, the RFID-tag may be characterized in view of its interference reliability value. In particular, the RFID-tag may be scanned in order to achieve values of the selected physical parameter in order to map the RFID-tag with respect to its interference reliability values. Thus, a map or matrix of the RFID-tag may be generated which represents the different portions or parts of the RFID-tag and the respective interference reliability values. By using the information of the determined interference reliability values it may be possible to provide an efficient way to locate a part and/or orientation of the RFID-tag which, when the tag is affixed to an object, may ensure that the RFID-tag is least affected by the nature of the object. In particular, by providing a map of determined interference reliability values in form of a two or three dimensional matrix there may be provided an efficient way to categorize the RFID-tag with respect to suitable and improper parts or orientations of the RFID-tag. That is, it may be ensureable to always determine the optimum place and/or orientation to attach the RFID-tag by determining interference reliability values for each point on the surface of the RFID-tag.

The aspects defined above and further aspects of the invention are apparent from the examples of embodiment to be described hereinafter and are explained with reference to these examples of embodiment.

### BRIEF DESCRIPTION OF THE DRAWINGS

The invention will be described in more detail hereinafter with reference to examples of embodiments but to which the invention is not limited,

FIG. 1 schematically illustrates an RFID tag,

FIG. 2 schematically illustrates a different RFID-tag,

FIG. 3 schematically illustrates results of a determined threshold power for different materials and frequencies, and

FIG. 4 schematically illustrates an attaching system.

### DESCRIPTION OF EMBODIMENTS

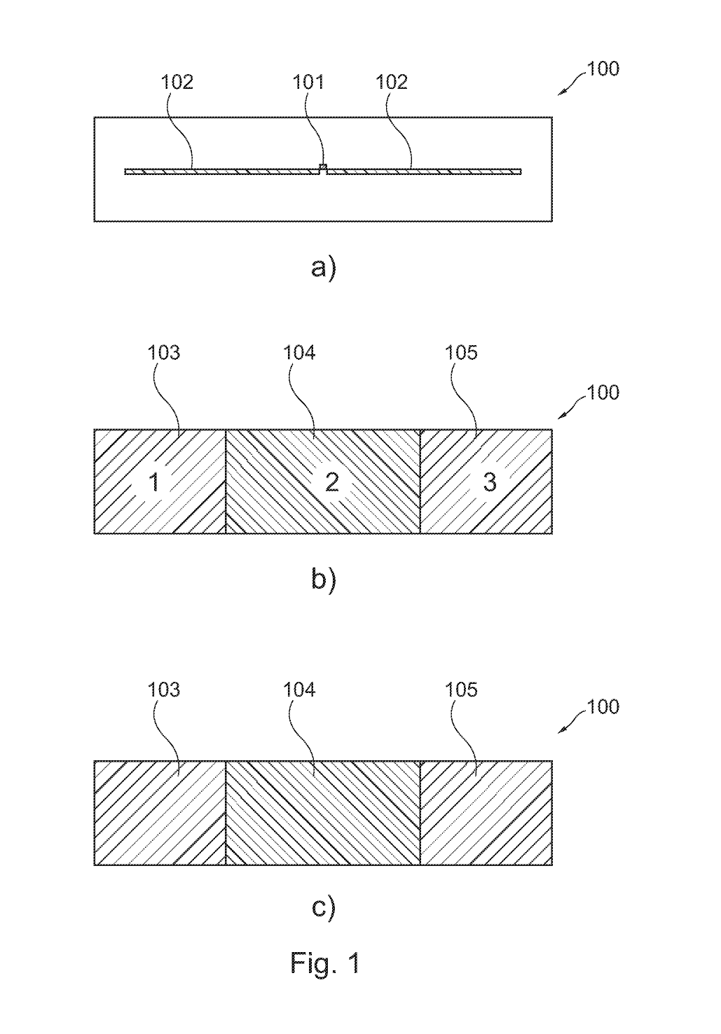

The illustration in the drawing is schematical. In different drawings, similar or identical elements are provided with the same reference signs. For the following illustration of the method and the element it is referred to FIGS. 1 to 3.

FIG. 1a schematically shows an example of an RFID-tag or RFID-label 100, which comprises an Integrated Circuit (IC) or a polymer structure 101 and an antenna 102. The IC 101 is connected to the antenna 102. Typically an RFID-tag 100 is based on one or more substrates that form the RFID tag/label 100.

FIG. 1b schematically shows the RFID-tag 100 of FIG. 1a which is split into three different zones or portions 103, 104 and 105. These portions may represent zones in which a physical parameter, e.g. relative dielectric constant or relative permeability, have different values. The difference in the values of the physical constant is schematically indicated by the different hatching. From these different values of the physical parameters different interference reliability values for the zones may arise, which is schematically shown by the numerals 1, 2 and 3 depicted in the three zones. For smaller RFID-tags or if the split into different zones is not wanted, only one interference reliability value for the whole RFID-tag may be used. To illustrate this, FIG. 1c does not show depicted numerals in the different zones 103, 104 and 105.

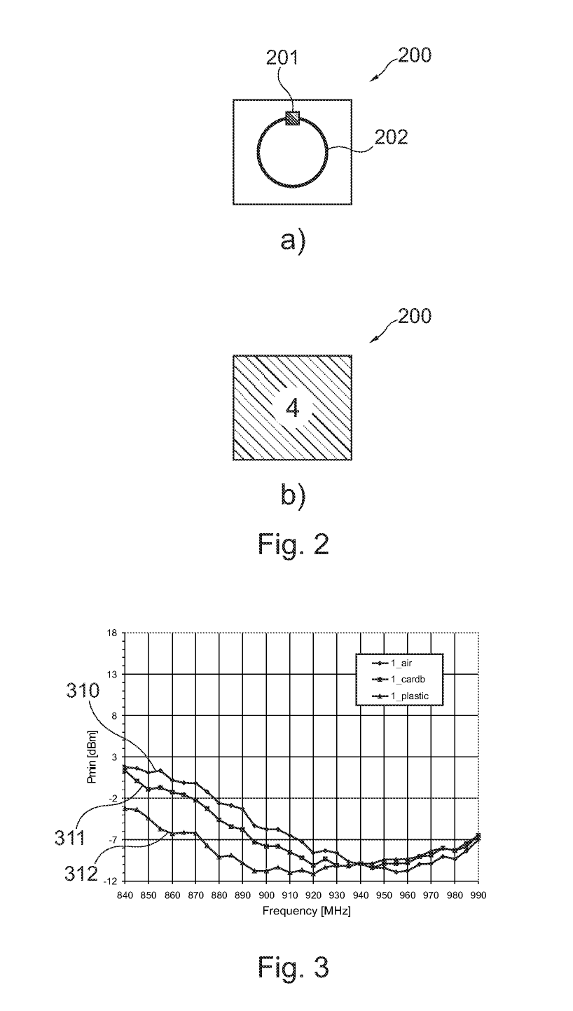

FIG. 2a schematically shows another example of an RFID-tag or RFID-label 200, which comprises an Integrated Circuit (IC) or a polymer structure 201 and an antenna 202. The IC 201 is connected to the antenna 202. Typically an RFID-tag 200 is based on one or more substrates that form the RFID tag/label 200. In the example shown in FIG. 2 the antenna 202 has a circular shape. However, other closed shapes of the antenna 202 are also possible.

FIG. 2b schematically shows the RFID-tag 200 of FIG. 2a. According to the shown example a sampled physical parameter, e.g. relative dielectric constant or relative permeability, has a constant value, or it is not intended to split the RFID-tag into different zones due to the intended application the RFID-tag 200 is used. This constant value of the physical parameter is indicated by the numeral 4, which may for example correspond to the relative dielectric constant of the RFID-tag, i.e. the RFID-tag may have a relative dielectric constant ∈ of 4.

According to an exemplary embodiment of the invention the type of the important physical parameter(s), e.g. the relative dielectric constant, may be stored on the RFID-tag memory and/or may be represented by a defined code, e.g. a bar code on the reel. Additionally, the value of the physical parameter(s) may also be stored on the RFID-tag memory.

In general there are various possibilities how to represent data, e.g. the measured values or determined interference reliability values, inside the RFID-tag memory. In the following, one exemplary way is described for single and multi parameter representation inside an RFID-tag/label user memory.

For example a small RFID-tag, e.g. as schematically shown in FIG. 2, may be designed to work best on a material with a dielectric constant of 4.0. Due to the limited bandwidth of the RFID-tag, the performance in terms of read is a maximum if this RFID-tag is applied onto material with the same dielectric constant. This may represent the maximum performance with respect to the read range. One way of measuring this performance is to place the label in a fix distance in front of an RFID reader antenna inside an anechoic chamber and increase the output power of the reader as long as the tag starts to operate. Alternatively, also the opposite procedure may be used, where the power is decreased, after starting from a maximum. This will yield into one or two threshold power levels at a frequency of interest. If the dielectric constant of the tagged material, e.g. a product to which the RFID-tag is applied, changes to higher or lower dielectric constants, the threshold power level changes to higher levels and thus the performance decreases. The decrease of performance compared to the matched threshold power level is called sensitivity.

Depending on the bandwidth of the RFID tag/label different ways of calculating the sensitivity σ of the RFID tag/label are possible. For relatively high Q RFID tag/labels (e.g. Q>12) the sensitivity can be calculated using equation 1:

$${σ}_{n} = \frac{Δ {P}_{MIN}}{Δ ɛ} [ dB \text{/} {Fm}^{- 1} ] \qquad Equation 1$$

wherein:
P_{MIN} represents the threshold power;
∈ represents the dielectric constant; and
σₙ is given in dB per Fm⁻¹

Using the described method and measuring the ΔP_{MIN} for different dielectrics is shown in the FIG. 3. Three P_{MIN} curves for air (∈ᵣ ˜1), cardboard (Eᵣ=2) and plastic (Eᵣ=4) have been measured and are depicted in FIG. 3. A first line 310 represents the P_{MIN} for different frequencies and for air, a second line 311 represents the P_{MIN} for different frequencies and for cardboard, while a third line 312 represents the P_{MIN} for different frequencies and for plastic. The used RFID-tag has been designed for plastic, i.e. for a relative dielectric constant of ∈ᵣ=4. At 910 MHz the P_{MIN} for plastic is −11.0 dBm in the used setup. This yield into a ΔP_{MIN1}=2.5 dB for cardboard and ΔP_{MIN2}=4.5 dB for air at 910 MHz. Applying equation 1 yields into sensitivities σ of:

$${σ}_{1} = \frac{Δ {P}_{MIN 1}}{Δ {ɛ}_{1}} = \frac{2 , 5 dB}{2 {Fm}^{- 1}} = 1 , 25 \frac{dB}{{Fm}^{- 1}}$$

$${σ}_{2} = \frac{Δ {P}_{MIN 2}}{Δ {ɛ}_{2}} = \frac{4 , 5 dB}{3 {Fm}^{- 1}} = 1 , 5 \frac{dB}{{Fm}^{- 1}}$$

$$\overline{σ} = \frac{1}{n} {\sum }_{n} \vert {σ}_{n} \vert$$

$$\overline{σ} = \frac{\vert {σ}_{1} + {σ}_{2} \vert}{2} = 1 , 375 \frac{dB}{{Fm}^{- 1}}$$

The mean value for the sensitivity can be written into the RFID tag/label memory or reel together with the operating frequency, reference threshold value and reference dielectric constant. The value of the sensitivity and/or the mean value of sensitivity may be used as an interference reliability value according to the present invention.

If low Q RFID tag/labels are used with a very flat P_{MIN} curve or more accuracy is needed, an integral of the P_{MIN} function may be used to represent the sensitivity. In most cases the measurement will be represented with discrete values, thus possibly requiring the use of a summation.

In particular, in the simple approach, in which only one value representing the optimum condition of usage for the whole area of the RFID-tag and the whole frequency range of the RFID-tag is used, the following parameters may be stored in an RFID tag/labels memory:

1. Frequency at which the physical parameter(s) are measured and which may correspond to the frequency at which the RFID-tag is used, e.g. 910 MHz.

2. Targeted parameter value, i.e. the value of the physical parameter of the object the RFID-tag can be applied to have the optimum performance, e.g. ∈=3 Fm⁻¹.

3. Sensitivity of targeted parameter value against a defined performance parameter like threshold power (P_{MIN}) e.g. σ=1.4 dB/Fm⁻¹.

This stored value represents the sensitivity of the used RFID tag/label and may be read from a RFID label applicator or printer including an applicator or printer as such and may be used together with a method of characterizing an object so that an optimal placement of RFID tag/labels on objects and/or products may be ensured. Such a method of characterizing objects may comprise the characterization of the object with respect to their relevant parameters via a matrix-based measurement of the selected parameter. The generated data may be used to detect the area that has lowest possible impact on an affixed RFID-tag or RFID-label and therefore may enable best performance of the used technology. Thus, an apparatus implementing said method may be used for finding the optimal RFID-tag/label placement that best fits to the tag/label infrastructure, e.g. the design of the tag. Furthermore, such an apparatus may be suitable to categorize products depending on their parameters and therefore may find the best combination of RFID tag/label and/or placement on objects/products.

If more than one zones should be taken into consideration, e.g. for large RFID tag/labels, the procedure described above is done for each of the zones, due to the fact that they may have different sensitivities to the change of the parameter of interest. The easiest way of getting the sensitivity of the zones may be to use a field simulator that has been used to design the antenna of the RFID tag/label.

A possible parameter set that can be stored in the memory could be the following:
1. RFID tag/label length x (in inch or cm)
2. RFID tag/label width y (in inch or cm)
3. Type of parameter (∈ᵣ, ∈, μᵣ, μ, Q, . . . ), wherein the type of parameter may be defined or standardized
4. Centre of optimal value (x-zone (inch or cm), y-zone (inch or cm))
5. Centre of zone sensitivity (x-zone (inch or cm), y-zone (inch or cm)), wherein the centre of zone sensitivity refers to the position of a centre of a zone for which zone or segment a sensitivity is defined or calculated, e.g. to a zone or portion of the RFID-tag.

There are many other possibilities to store the data inside the memory, depending on the size and accuracy. If the size of the memory is large, the best way may be to store one value for the threshold power (P_{MIN}) per frequency within a dedicated range inside the RFID-tag/label. For example an UHF RFID tag/label stores values from 860 MHz to 960 MHz with 10 MHz steps, thus yields into 11 values for (P_{MIN}) plus the type of targeted parameter (e.g. ∈ or ∈ᵣ) one value for the targeted parameter and one value for the sensitivity that applies for all frequencies. Alternatively, a second array of sensitivity values can be stored, one for each frequency if the RFID-tag memory allows it.

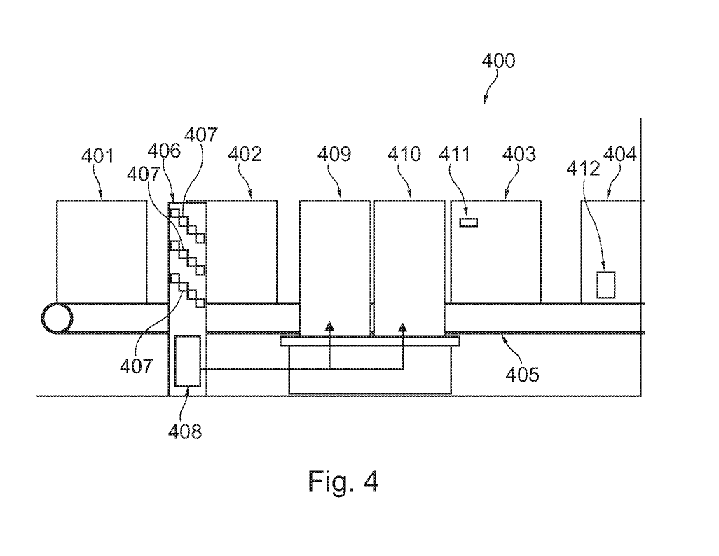

FIG. 4 schematically illustrates a system 400 for attaching a contactless transmission element onto an object according to an exemplary embodiment. FIG. 4 schematically shows a first box 401, a second box 402, a third box 403 and a fourth box 404. All these boxes are placed on a conveyor 405 which transports the boxes in FIG. 4 from the left to the right. Furthermore, the system 400 comprises a sensor array 406 comprising a plurality of staggered sensor elements 407. According to FIG. 4 the sensor elements are arranged in three diagonal lines, however other arrangements are also possible. Additionally, the system 400 comprises a determination unit 408, which may be formed by an electronic circuit, and which is adapted to analyze the data measured by the sensor array. The determination unit 408 may be placed in a housing together with the sensor array. Furthermore, the system 400 comprises an RFID-tag printer which comprises two sub-units 409 and 410, wherein one of the sub-units 409, 410 is adapted to print one kind of RFID-tags while the other sub-unit is adapted to print another kind of RFID-tags. The two sub-units may be replaced by one unit which is adapted to print different kinds of RFID-tags. The RFID-tag printer may also comprise an attaching unit and/or a reading unit, wherein the attaching unit is adapted to attach a newly printed or stored RFID-tag to the box and wherein the reading unit is adapted to read interference reliability values from a storing medium.

The RFID-tag printer may also be replaced by a simple attaching and/or reading unit which does not have the ability to print an RFID-tag but only to attach and/or to read the necessary values from a storing unit. The RFID-tag printer is connected to the determination unit 408 so that the printer may receive instructions which kind of RFID-tags has to be printed for the respective box. Moreover, the system 400 comprises an attachment unit which is according to the system shown in FIG. 4 a part of the sub-units 409 and 410 of the printer. However, the attachment unit may be formed by a separate unit or the printer may print the RFID-tag directly onto the box at the optimum position or in an optimum orientation. In FIG. 4 are also shown two RFID-tags 411 and 412 which are already applied to the third box 403 and the fourth box 404, respectively. The RFID-tags are attached to the boxes at positions which are most suitable for this attaching, i.e. positions at which the function of the RFID-tag is least disturbed by the boxes and/or the respective content of the boxes. The respective positions depend on the one side of the measured and/or determined impact values of the box and on the other side on the interference reliability values determined for the specific RFID-tag. The respective interference reliability values for specific RFID-tags printable by the printers or stored on a reel and applyable to the box, may be stored either direct on the used RFID-tags or in a memory being part of the system, e.g. of the determination unit 408. The first RFID-tag 411 is applied to the third box 403 at the upper left, while the second RFID-tag 412 is applied to the fourth box 404 at the lower left. Summarizing, FIG. 4 shows an example of a real-time objects/product characterization for boxes on a conveyor that does an automatic selection between two different RFID label infrastructures and automatic placement of the RFID tag/label, depending on the measured gradient of the selected parameter(s).

In the system 400 shown in FIG. 4 the RFID relevant characterization of objects/products can be used to provide an independent frequency selection for RFID applications and selection of the technology that best fits to the requirements of the application and their respective environmental and physical limitations. The optimal placement of an RFID tag/label on the object/product that yields into the targeted performance as well as material quality and/or reliability could be derived from the characterization profiles. Knowing the profile of RF relevant parameters allows a frequency independent selection of RFID infrastructure that matches to the application and yields into optimal performance.

The boxes coming from the left side in FIG. 4 are uncharacterized. By passing by the sensor array the characterization is processed. For higher speed or lower interference, the sensor array can be organized as shown in FIG. 4. The result of the characterization is used to select the best matching infrastructure, based on the classification of the parameter(s) and the available infrastructure. In this example, two sub-units of the RFID label printer are present with two different RFID label types are installed. Those printers have the capability of printing an RFID label on any height of the box, for optimal RFID label placement. The geometrical separation of the sensor array used for the characterization and the printers allow the printers to adjust to the computed location on which the RFID label should be applied. If the printer is fast enough, the characterization unit can also be integrated into the printer itself. The described application allows an optimal tag/label selection and placement and therefore yield into better performance of RFID as such without affecting the high product throughputs common in most logistic processes.

Finally, it should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. In a device claim enumerating several means, several of these means may be embodied by one and the same item of software or hardware. The mere fact that certain measures are recited in mutually different dependent claims does not indicate that a combination of these measures cannot be used to advantage.

1. A method of characterizing a contactless transmission element, the method comprising:
sampling a first value of a first physical parameter indicating a property of a contactless transmission element; and
determining an interference reliability value for the contactless transmission element based on the sampled first value of the first physical parameter.

2. The method according to claim 1 further comprising:
storing the determined interference reliability value.

3. The method according to claim 2,
wherein the interference reliability value is stored on the contactless transmission element.

4. The method according to claim 3,
wherein an indication is printed on the contactless transmission element corresponding to the interference reliability value.

5. The method according to claim 3,
wherein the interference reliability value is stored on a memory of the contactless transmission element.

6. The method according to claim 2,
wherein the interference reliability value is stored on a carrier element of the contactless transmission element.

7. The method according to claim 1, further comprising:
sampling a plurality of values of the first physical parameter.

8. The method according to claim 7,
wherein each of the plurality of values of the first physical parameter is indicative of a property of a respective portion of the contactless transmission element.

9. The method according to claim 8, further comprising:
determining a plurality of interference reliability values based on the plurality of sampled values of the first physical parameter.

10. The method according to claim 9, further comprising:
estimating a specific interference reliability value based on the plurality of interference reliability values.

11. The method according to claim 10,
wherein the estimating is performed by selecting the minimum value of the plurality of interference reliability values or by calculating the mean value of the plurality of interference reliability values.

12. The method according to claim 10, further comprising:
storing a position value, wherein the position value corresponds to the portion of the contactless transmission element the estimated specific interference reliability value corresponds to.

13. The method according claim 2,
wherein a plurality of information values is stored which relate to the interference reliability value.

14. The method according claim 13,
wherein at least one of the plurality of information values is one out the group consisting of:
a length of the contactless transmission element;
a width of the contactless transmission element;
the type of the first physical parameter;
a position on the contactless transmission element which position is associated with the lowest interference reliability value;
a position of an area on the contactless transmission element wherein the area is associated with a substantially constant interference reliability value; and
an operating frequency of the contactless transmission element.

15. The method according to claim 1,
wherein the first physical parameter is one out of the group consisting of:
relative permeability;
relative dielectric constant; and
lossy angle.

16. The method according to claim 1, further comprising:
sampling a second value of a second physical parameter.

17. The method according to claim 1,
wherein the sampling is done by using a field simulator, adapted to generate an electro-magnetic field.

18. A method of placing a contactless transmission element on an object, the method comprising:
reading an interference reliability value determined by carrying out the method according to claim 1;
correlating the interference reliability value for the contactless transmission element with an impact value of the object, wherein the impact value characterizes an impact of the object on a transmission of the contactless transmission element; and
placing the contactless transmission element on the object based on the result of the correlation.

19. A contactless transmission system, comprising:
a contactless transmission element; and
an information storing element adapted to store information indicative for an interference reliability value for the contactless transmission element.

20. The contactless transmission system according to claim 19,
wherein the contactless transmission element is an RFID-tag.

21. The contactless transmission system according to claim 19,
wherein the contactless transmission element and the information storing element are arranged on a common substrate.

22. The contactless transmission system according to claim 19,
wherein the information storing element is arranged on a stocking structure of the contactless transmission element.

23. The contactless transmission system according to claim 19,
wherein the information storing element is one out of the group consisting of:
an RFID-tag;
a bar code; and
a machine-readable medium.

24. An attaching system for attaching a contactless transmission element onto an object, the system comprising:
a contactless transmission element attaching unit; and
a reading unit;
wherein the reading unit is adapted to read an interference reliability value determined according claim 1;
wherein the reading unit is further adapted to read an impact value of the object, wherein the impact value characterizes an impact of the object on a transmission of the contactless transmission element; and
wherein the contactless transmission element attaching unit is adapted to attach a specific contactless transmission element based on the read interference reliability value and on the read impact value.

25. A program element, which, when being executed by a processor, is adapted to control or carry out a method of characterizing a contactless transmission element, the method comprising:
sampling a first value of a first physical parameter indicating a property of a contactless transmission element; and
determining an interference reliability value for the contactless transmission element based on the sampled first value of the first physical parameter.

26. A computer-readable medium, in which a computer program is stored which, when being executed by a processor, is adapted to control or carry out a method of characterizing a contactless transmission element, the method comprising:
sampling a first value of a first physical parameter indicating a property of a contactless transmission element; and
determining an interference reliability value for the contactless transmission element based on the sampled first value of the first physical parameter.
